(19) United States
(12) Patent Application Publication
(10) Pub. No.: US 2018/0072384 A1
(43) Pub. Date: Mar. 15, 2018

(54) Electronic Bilge Pump Switch with Monitoring and RF Communication, Apparatus and System

(71) Applicant: Clay Werner von Mueller, San Diego, CA (US)

(72) Inventor: Clay Werner von Mueller, San Diego, CA (US)

(21) Appl. No.: 15/266,821

(22) Filed: Sep. 15, 2016

(51) Int. Cl. B63B 13/00; H04L 29/08; H04W 4/00; G05D 9/00

(52) U.S. Cl. CPC B63B 13/00; H04L 67/025; B63J 2099/006; G05D 9/00; H04W 4/006

(57) ABSTRACT

An electronic controller for a bilge pump providing the functions of monitoring liquid level in a boat bilge, and controlling the operation of the bilge pump, and monitoring the bilge pump operation, including bilge temperature, the bilge pump current and voltage, and maintaining a log of the collected data and providing the data to a remote device. In addition, the pump controller dynamically adjusts the bilge pumps operation based on commands received from a remote device and the logged data. In addition, the system monitors for hazardous materials within the bilge fluid preventing discharge within protected water ways.

### CROSS-REFERENCE TO RELATED APPLICATIONS

Not Applicable

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The field of the present invention generally relates to sensors for detecting the presence of fluids for activating a pump, and more specifically, to fluid sensors mounted in boat bilge tanks for activating a bilge pump when bilge fluid reaches a preset level above the bottom of the bilge tank, logging operational data and sending informational data along with alerts and statistical data to remote devices.

### BACKGROUND OF THE INVENTION

All boats or ships accumulate liquids, including mostly water, in there bilge area. Bilge pumps must be activated before the accumulating liquids reach an excessive level, causing damage to or sinking the vessel. Early bilge pumps were activated manually or by mechanical switches such as those that have floats with contacts to complete electrical circuits and activate the bilge pumps. These mechanical switches typically performed as desired when initially installed on the boats. However, bilge debris and other contamination built up over time and/or caused corrosion to prevent the mechanical components from moving as intended. In addition, some contaminants including oil are prohibited from being discharged into public waterways. Additionally, these mechanical switches had relatively short lives compared to the boats in which they were installed and required replacement. When a sump switch fails there is no direct warning that the vessel is taking on water. Boats docked in their slip rely on shore power to maintain the battery which powers the bilge pump. If shore power is lost or the sump switch malfunctions and the problem is not detected, the damage caused to the vessel can be extreme. If water reaches the floor board of the saloon in a yacht, from the exterior the problem can go unnoticed while the damage to the engines can be tens of thousands of dollars.

In an attempt to solve these problems with mechanical switches, electronic switches with and without moving parts were developed. Typically, these electronic switches utilize the conductivity of the water, the dielectric constant or the index of refraction of water, to be sensed with probes to activate the bilge pumps. These electronic switches must be calibrated during the manufacturing process and are susceptible to operational errors, including loss of calibration and false negative and false positive detection of liquid level, which can cause the pump to stay on continuously damaging the pump or, not starting the pump when the desired water activation level is reached.

Many attempts have been made to solve these problems with electrical capacitive switches. Coated water repellant probes have been used. For example, see U.S. Pat. No. 4,276,454, the disclosure of which is expressly incorporated herein in its entirety by reference. Ultrasonic field detection has been utilized. For example, see U.S. Pat. No. 4,881,873, the disclosure of which is expressly incorporated herein in its entirety by reference. Acoustic transducers have been utilized. For example, see U.S. Pat. No. 4,897,822, the disclosure of which is expressly incorporated herein in its entirety by reference. Time delays have been utilized. For example, see U.S. Pat. No. 5,404,048, the disclosure of which is expressly incorporated herein in its entirety by reference. Optical fibers have been utilized. For example, see U.S. Pat. No. 5,425,624, the disclosure of which is expressly incorporated herein in its entirety by reference. Field effect “touch sensors” have been utilized. For example, see U.S. Pat. No. 7,373,817, the disclosure of which is expressly incorporated herein in its entirety by reference. While these attempts may have been somewhat successful in reducing false alarms and missed detections, they are either not completely successful or relatively expensive devices, or requiring additional wiring to be added to supply voltage to operate the electronic switch. Accordingly, there is a need for improved bilge pump switches that are less costly and reduce false alarms and missed detections and require no modification to the existing bilge pump wiring.

### SUMMARY OF THE INVENTION

Disclosed herein are bilge pump switches which overcome at least one of the deficiencies of the prior art. Disclosed is a switch for a bilge pump comprising, in combination, a self-calibrating non-contact projected field capacitance liquid sensing, pump current voltage and temperature monitoring, a controller with non-volatile memory for storing operational parameters and logging data, and a wireless communication module.

Also disclosed is a switch for a bilge pump comprising, a self-calibrating capacitance liquid sensor capable of distinguishing between various liquids commonly found in bilge water. If oil is present in the bilge water the pump will be prevented from dispersing the oil into the water way. In addition, the wireless communication module and the sump switch alert indicator are used to notify the vessel operator of the oil condition, allowing the bilge to be emptied in a non-environmentally damaging manner.

Also disclosed is a switch for a bilge pump comprising, in combination, multiple capacitive sensing probes, the probes located at varying distances from the switch base, for providing a signal indicating the presence of fluid level in the bilge, and a controller programmed to energize the pump when the threshold level of the probe signal indicates the presence of fluid at a specific level. The controller is programmed to activate the pump when the liquid level reaches a predetermined specific level.

Also disclosed is a self-monitoring switch for a bilge pump with a controller programmed, to periodically monitor and log the operation of the pump, including the pump current, supply voltage, bilge temperature, pump vibration, number and duration of pump activations. If any of the monitored parameters exceed a predetermined level an alert is sent via the wireless communication module and visual indicators on the switch are enabled.

Also disclosed is a self-monitoring switch for a bilge pump including a secondary power source, capable of providing power to the communication module, for communicating with devices external to the bilge switch, using the wireless communication module to send an alert, if the bilge pump power is lost.

Also disclosed is a bilge pump switch employing redundant level sensing devices, including a combination, multiple capacitance liquid sensors, optical index of refraction liquid level sensors, and multiple liquid level float sensors, monitored in parallel to provide a redundant level sensing solution.

Also disclosed is an electronic bilge pump switch which directly replaces a passive mechanical switch, without the requirement of any additional wiring or concern for connection polarity, including a bidirectional DC and AC electronic switch circuit used to replace a conventional mechanical switch, providing electronic control of voltage and current passing from one terminal of the switch connection to the other switch connection. The circuit may also be placed in parallel with an existing mechanical bilge pump switch to control bilge pump in tandem with the mechanical switch and further monitor the mechanical bilge pump switches operation providing redundant operation of the bilge switch to prevent false negative and false positive pump operation.

Also disclosed is a smart phone application compatible with said bilge switch wherein the software application provides a user interface to display the operational parameters and the current operational status of the bilge switch. In addition, the smart phone application enables audible and visual alarms if the operation status of the bilge switch is outside of the operation parameter limits. In addition, the smart phone application sets or changes the operation parameters of the bilge switch based on user input through the software application user interface.

Also disclosed is a bilge switch data concentrator, which is within the vessel, and contains a RF wireless transceiver compatible with said bilge switch and a controller programmed to scan for compatible electronic bilge switch controllers aboard the vessel, and display the alarm, operational and informational data at a convenient location to the vessels captain or crew.

Also disclosed is a bilge switch data concentrator, which is within the vessel, and contains a RF wireless transceiver compatible with said bilge switch and a second RF wireless transceiver capable on sending and receiving data over RF networks, including GSM and CDMA cellular networks, WiFi 802.11 internet connected networks and satellite networks, and a controller programmed to relay bilge switch informational and operational data to a remote device with compatible software application.

Also disclosed is a bilge switch data concentrator application, which scans for said electronic bilge switches installed within a vessel and relays the operational parameters and status parameters to a remote device using satellite, cell phone, or WiFi wireless RF networks.

Also disclosed, is a remote data collection and processing device compatible with the bilge switch data concentrator, that is programmed to process it the informational and status data sent by compatible bilge switch data concentrators, and send notification of the status of compatible electronic bilge switch controllers to predetermined electronic devices, including smartphones and internet connected devices with compatible applications, to display vessel informational and status information.

Also disclosed, is remote vessel informational and status information smartphone application to provide vessel alarm information to dock masters, allowing faulty bilge pump operation to be detected and corrected prior to vessel damage.

From the foregoing disclosure and the following more detailed description of various preferred embodiments it will be apparent to those skilled in the art that the present invention provides a significant advance in the technology and art of bilge pump switches. Particularly significant in this regard is the potential the invention affords for providing a reliable switch with self-monitoring and control capabilities. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is an illustration view of a bilge pump system of a boat according to the present invention;

FIG. 2 is a perspective view of bilge pump switch of the system of FIG. 1;

FIG. 3 is a perspective view of bilge pump switch sample tank of FIG. 1;

FIG. 4 is a sectional view of bilge pump switch electronic switch with capacitance sensors for monitoring the bilge liquid level and sample tank materials of FIG. 2;

FIG. 5 is schematic view of a polarity insensitive electronic circuit of the bilge pump power switch controller with auxiliary power source according to the present invention;

FIG. 6 is schematic view of an alternative polarity insensitive electronic circuit of the bilge pump power switch controller with auxiliary power source according to the present invention;

FIG. 7 is a schematic view of the sump switch controller with wireless module according to the present invention;

FIG. 8 is an illustrated view of the monitoring and control application according to the present invention;

FIG. 9 is an illustrated view of the remote bilge monitoring and control system according to the present invention;

It should be understood that the appended drawings are not necessarily to scale, presenting a somewhat simplified representation of various preferred features illustrative of the basic principles of the invention. The specific design features of the bilge pump switch as disclosed herein, including, for example, specific dimensions, orientations, locations, and shapes of the various components, will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the bilge pump switches illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved bilge pump switches disclosed herein. The following detailed discussion of various alternative and preferred embodiments will illustrate the general principles of the invention. Other embodiments suitable for other applications will be apparent to those skilled in the art given the benefit of this disclosure.

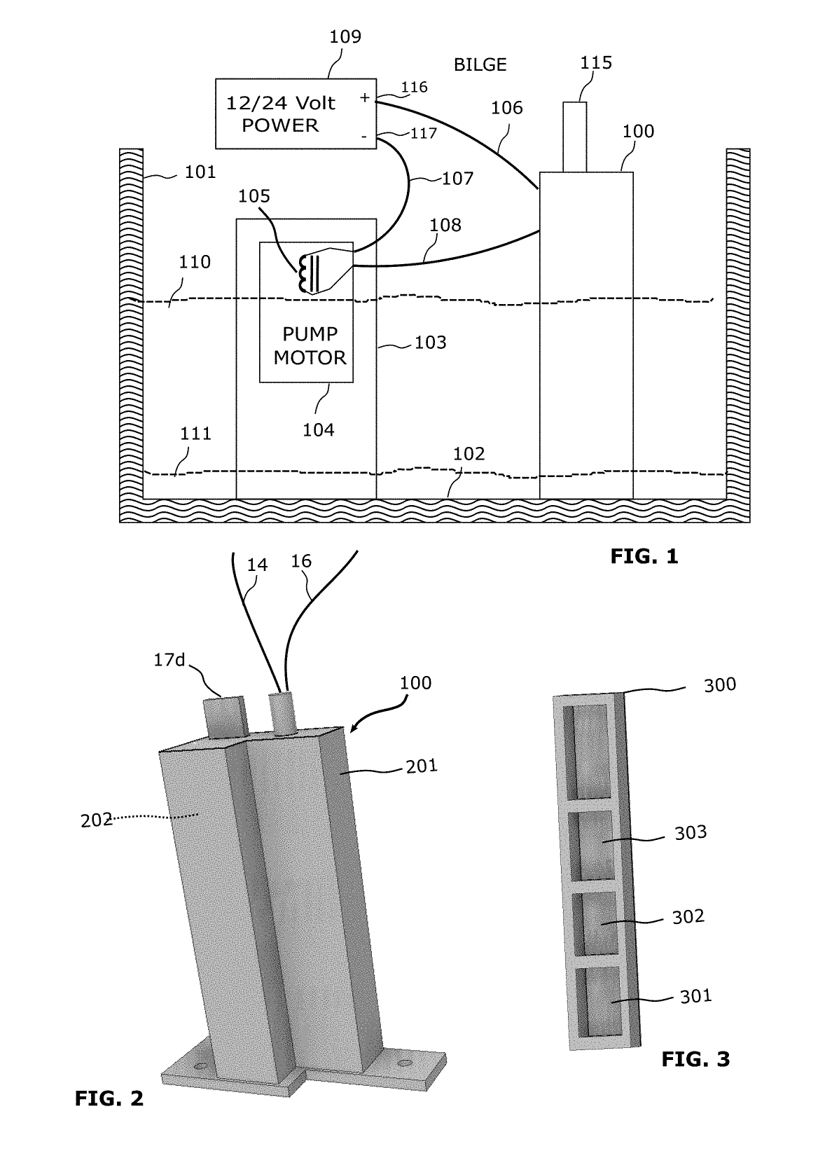

Referring now to the drawings, FIGS. 1 to 9 illustrate a bilge pump switch 100 according to the present invention. The illustrated bilge switch 100 is mounted at the bottom of a bilge in a boat 101 and is electrically connected to a 12 volt power source 109, and a bilge pump 103 in order to selectively energize the pump and evacuate the water 110 and other bilge fluids in the bilge 102 of the boat 101. As best shown in FIGS. 2-4, the illustrated bilge pump switch 100 includes a protective case or housing 201, an electronic circuit 401 within the case 201, and multiple probes 402, 403, 404, 405 electrically connected to the electronic circuit 700 at capacitance sensor inputs 702,703,704,705, for detecting liquid level within the bilge 102 using water protected case 201 to act as a water level sensor and bilge pump switch 100. The bilge pump switch 100 also contains multiple probes 406, 407, 408 isolated from the bilge liquid and physically close to the calibration sample tank 300, which is located in cavity 202 of the bilge switch 100, and electrically connected to the electronic circuit 700 at sample sensor inputs 706, 707, 708 for providing self-calibration data from samples reservoirs 301, 302, 302 within sample tank 300, used for calibration samples of materials to be sensed, including and not limited to, air, water, salt water, and oil. The bilge pump switch 100 also contains a probe 409, connected to electronic circuit 700 at sample sensor input 709 for detecting finger touching to activate control functions within the switch such as pairing for the wireless communication module.

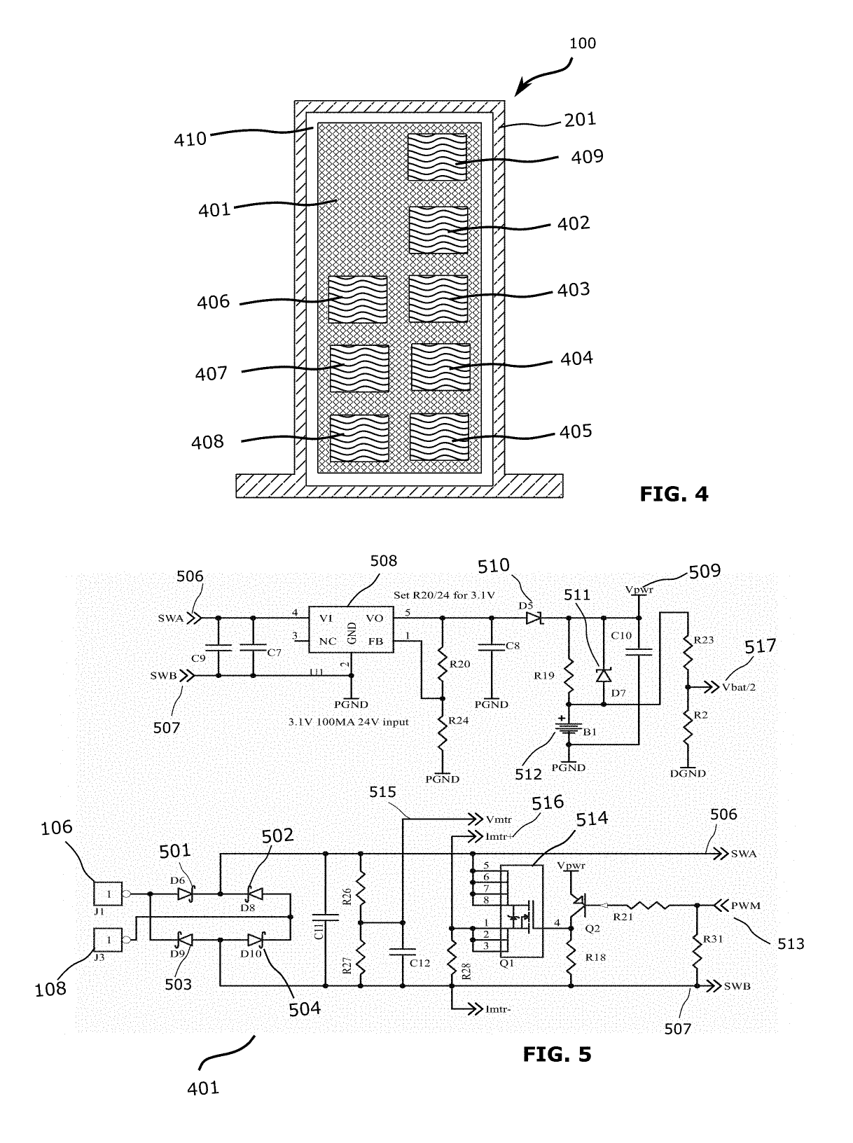

Referring to electronic circuit of FIG. 5 which controls the current flow from the bilge power source 109, positive terminal 116, to the bilge switch electronic circuit 106, the alternate connection from the bilge switch 108, to the pump motor 105, and the circuit being completed by connection 107 from the power source 109 negative terminal 117 to the pump motor 105. The connection of the bilge switch 11, power source 109, and pump motor 105, is a standard series connection used for controlling mechanical bilge pumps. Unlike mechanical bilge switches, electronic bilge switches normally require three connections, power, ground, and pump control. The electronic bilge 100 presented, requires only two connections 106, 108. In addition the shown connection bilge switch connection 106 to power source 116 and switch connection 108 to pump motor 105 is reversed to the connection of the bilge switch connection 108 to power source 116 and switch connection 106 to pump motor 105, the bilge switch still operates correctly.

In addition referring to electronic circuit of FIG. 5, when the bilge pump motor 104 is idle, a small current flows from the power source 109 through the pump motor windings 105, through the sump switch connection 108 to the sump switch controller connection 106, and to the power source 109. This motor idle current is rectified by D6, D8, D9, and D10 (501, 502, 503, and 504), the rectified positive voltage 506, and the negative voltage 507, are regulated to 3.1V (508) providing power to operate the electronic circuit 401. It should be noted that the current flowing through the pump motor 105, during this idle state, is less than 100 MA, and is not sufficient to cause the motor 105 to activate.

In addition referring to electronic circuit of FIG. 5, when the bilge pump motor 105 is active, voltage from 506 and 507 decreases as the current though the pump winding 105 increases, until the output voltage of the regulator 508 drops below 3.1V, causing diode D5 (510) to stop conducting and D7 (511) to start conducting, powering the bilge switch 100 from battery B1 (512). It should be understood, that battery B1 (512) can be any electrical charge storage device, including and not limited to, a primary storage cell, a rechargeable battery, and a capacitor.

In addition referring to electronic circuit of FIG. 5, the bilge pump motor 105 is activated, by a control signal 513 from the bilge switch controller 700, causing the FET (514) to conduct, which lowers the resistance between 506 and 507, causing increased current to flow between input terminals 106 and 108, and through pump windings 105, causing the bilge pump 104 to activate.

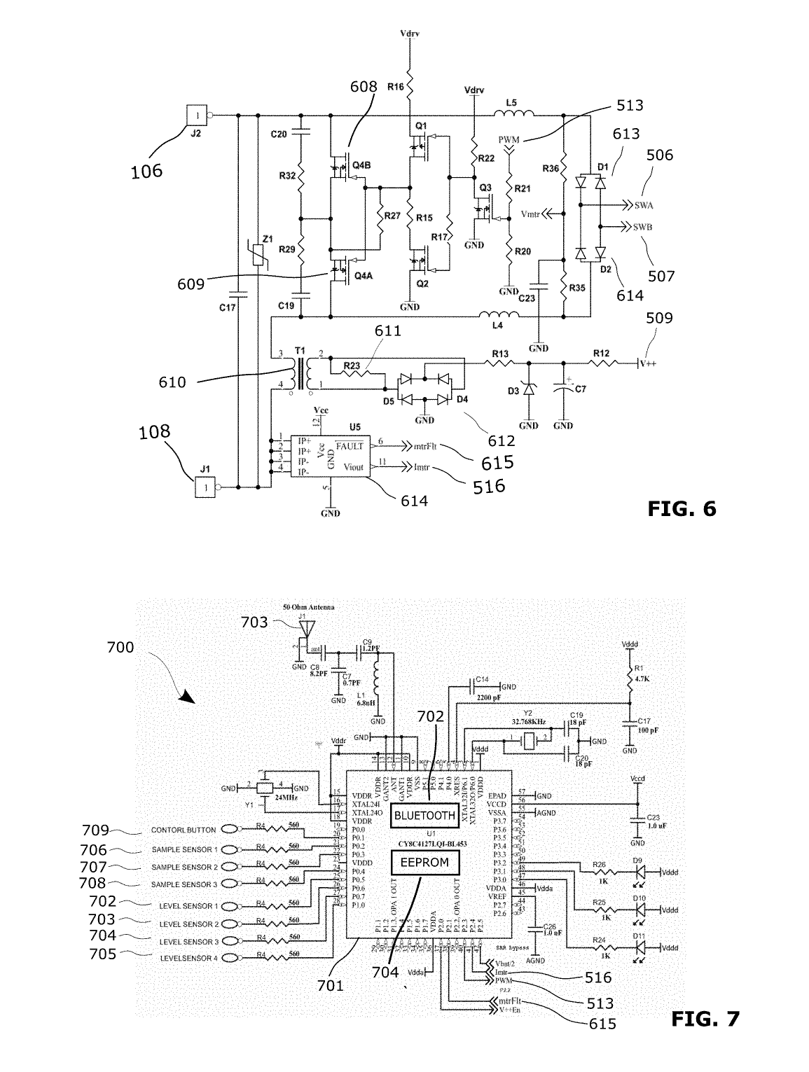

Referring to alternative electronic circuit of FIG. 6 which controls the current flow from the bilge power source 109 through the bilge pump motor 105, is activated, by a control signal 513 from the bilge switch controller 700, causing either FET 608, 609 to conduct, depending on the polarity of bilge inputs 106,107. The FET that is not made to conduct by the control signal 513, is reversed biased by the voltage at input terminals 108,109, causing its internal reversed bias diode to conduct, causing a current to flow between the input terminals 106, 108, causing the pump motor 104 to activate. In addition the shown connection bilge switch connection 106 to power source 116 and switch connection 108 to pump motor 105 is reversed to the connection of the bilge switch connection 108 to power source 116 and switch connection 106 to pump motor 105, the bilge switch still operates correctly.

In addition referring to alternative electronic circuit of FIG. 6, when the bilge pump motor 104 is inactive, a small current flows from the power source 109 through connection wire 107, through the pump motor windings 105, through the sump switch connection 108, to the sump switch controller connection 106, and to the power source 109. The voltage between the bilge switch inputs 106 and 108 is rectified by diodes 613, 614 and input to 3.1V regulated 508, via 506,507 to generate a regulated 3.1V to operate the electronic bilge switch circuit 700.

In addition referring to electronic circuit of FIG. 6, when the FETs 608, 609 are enabled, the resistance across bilge switch inputs 106, 108 is reduced, increasing the voltage across the pump motor winding 105, activating the bilge pump motor 104. The voltage across bilge switch inputs 106 and 108 decreases as the current through the pump winding 105 increases. As the pulse width modulated control signal 513, switches the conducting FET on and off, the pulsed voltage across the pump winding 105 increases in on time, causing the pulsed current through the transformer 610, to induce a voltage at 611 across resistor 611, which is rectified by bridge rectifier 612 to provide power 509, in addition to the power supplied by battery 512, while the bilge pump motor 104 is running. In addition referring to electronic circuit of FIG. 6, an active current sensor 517 is included to improve the accuracy of current measurement through the pump motor 105.

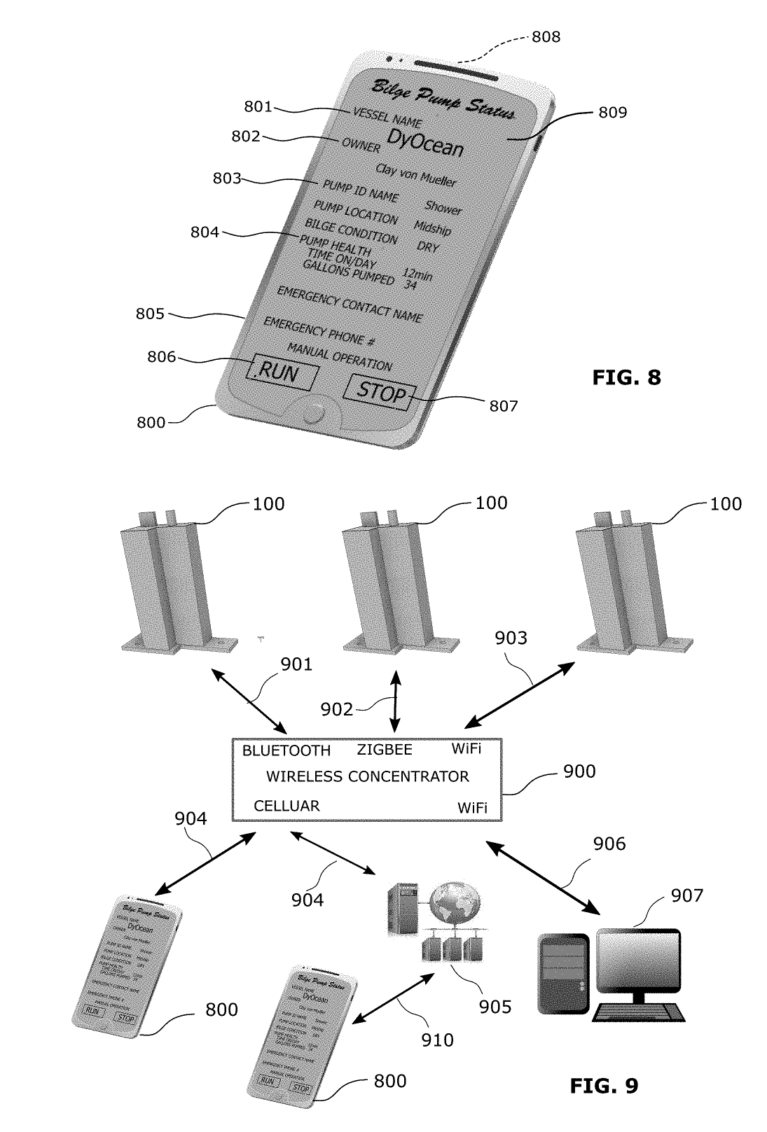

Referring to electronic circuit of FIG. 7, the bilge controller 401 monitors the water level within the bilge 102 via the four probes 402,403,404,405 and energizes the bilge pump 103 only when the water 110 or other bilge fluids within the bilge 102 reaches the level of the probe 402,403,404 or, 405 on the controller. The illustrated electronic circuit 700 also monitors current flow 516 through the bilge pump 103, using current sensor 614, and shuts off the bilge pump 103 when the current exceeds a predetermined value or when the motor fault 615 control output of the current sensor 614 is triggered. In addition, the controller 701 is programmed to monitor the current sensor 614, and disable the pump when the current level falls below a predetermined level indicating that the bilge 102, is empty of water 110 and other bilge fluids. The illustrated electronic circuit 700 dynamically changes a threshold or trigger signal value for the probes 402,403,404 and 405 based on changing probe conditions by self-calibrating using the sample self-calibration probes 406, 407, 408 in order to reduce false triggers and enhance the reliability of the bilge pump 103 to control the water level within the bilge 102. The illustrated electronic circuit 700 and controller 701 is programmed to log bilge switch parameters, including and not limited to, input voltage 515, auxiliary battery voltage 517, motor current 516, and ambient temperature, storing the logs in EEPROM 704.

In addition referring to electronic circuit of FIG. 7, microcontroller 701, which contains a Bluetooth wireless communication module 702, attached to a 50 ohm Antenna 703, and programmed for sending data, including alerts, bilge information including the bilge pump 103 location within the boat 101, log data including number of pump activations, total number of minutes the bilge pump has run. In addition, the wireless communication module 702, receives data, including installation information, such as the bilge location, the name of the vessel with contact information in case there is an error in operation of the bilge pump 103 or electronic bilge switch 100, requiring repair.

Referring the illustrated remote wireless monitoring and control device in FIG. 8, The smartphone 800, using it Bluetooth or WiFi wireless communication module 808, and bilge pump compatible software application 809, sends and receives data to a bilge switch 100. While the device illustrated is a cell phone 800, any device with a wireless module able to connect with the bilge switch 100, could be used, including and not limited to, ZigBee and custom wireless protocols, and device including tablets, PCs and dedicated the wireless concentrator of FIG. 9.

In addition referring to the illustrated remote wireless monitoring and control device of FIG. 8, the bilge pump software application 809, displays information stored in the bilge switch 100, including the vessel name 801, owner 802, bilge switch pump identifier 803, emergency contact information 805, along with bilge pump control functions to turn the pump on 806 and off 807. These functions are for illustrative purposes and in practice other information could also be displayed and other control functions activated. If the bilge pump health data 804, indicates that the amount of time the pump has run or the number of gallons the pump has evacuated are above the preset limits, an alert is sent using the cell phone 800, cellular wireless module using the emergency phone number 8006.

Referring the illustrated remote bilge switch wireless monitoring and control system in FIG. 9, multiple bilge switches 100, communicate identification data 803 and bilge status data 804 to the wireless concentrator 900, using Bluetooth 901, ZigBee 902 or Wi-Fi 903, which is located on the vessel 101. The wireless concentrator 900 controller application, forwards the received bilge switch data, using the Wi-Fi wireless link 906, to a computer 907 with a compatible application, located in the vessel or to the Dock Masters office for displaying the vessels status. In addition, the wireless concentrator 900, scans the received data from the bilge switches 100, if error or emergency conditions are contained in the data, the emergency contact information is used to forward the vessel status using cellular wireless connection 904 and using the emergency phone number 805.

In addition, referring the illustrated remote bilge switch wireless monitoring and control system in FIG. 9, the wireless concentrator 900 controller application, at programmed time intervals, requests all bilge data from each of the bilge switches 100, located on the vessel 101, and forwards the received data, using the cellular wireless link 904, to a server 905, which collects and organizes the data providing reports on the vessel using an internet connection 910. In addition, when the collected data indicates any previously defined notification request, a request is sent using either the internet 910 or a cellular connection 904.

As best shown in FIG. 7, the illustrated electronic circuit 700 includes a controller or microcontroller 701 and other electrical components (such as, for example, capacitors, resistors, diodes, transistors, relays, and the like) configured to provide the operations and functions described herein. The illustrated controller 701 is a 57-pin, flash based, 32 bit CMOS microcontroller but it is noted that any other suitable type of controller can alternatively be utilized. A suitable microcontroller is part no. CY8C4127LQI-BL-453 available from Cypress Semiconductors, 198 Champion Court San Jose, Calif. 95134 USA. The electronic components are mounted on at least one circuit board located within the sealed interior cavity 410 of the protective case 100, using waterproof epoxy filler.

It is noted that each of the features and variations of the above disclosed embodiments can be used in any combination which each of the other embodiments.

From the foregoing disclosure it is apparent that by monitoring the current draw of the bilge pump motor 104, the bilge pump 103 operates only as long as it takes to completely evacuate the bilge 102 of water and other bilge fluids 110 to an idle level 111. Prior art bilge pumps operate for a predetermined time period regardless of the capacity of the bilge. Operating for predetermined time periods can result in the pump running dry for long periods and thus reducing the life of the pump.

It is also apparent that by keeping a running average of the probe signal strength, and comparing the running averages of the probe in contact with the bilge liquid and to the self-calibration sensors, the bilge pump switch 100 has the ability to intelligently determine the state of the water level and water quality in the bilge 102. It is also apparent that if the bilge level sensors approximate the value of the self-calibrating sensor for oil, the bilge pump 103 should not be activated if the vessel 101 is located within protected waters. In this case an error status is set to notify the application 809, that hazardous material in the bilge fluid 110.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed:

1. An apparatus for controlling a bilge pump, the apparatus comprising in combination:
a waterproof enclosure containing:
a probe for providing a probe signal indicating the presence of fluid at the probe;
a probe in contact with an air sample for providing an air threshold level;
a controller in communication with the probes to receive the probes signals;
an electronically activated switch for controlling a bilge pump motor;
wherein the controller is programmed to compare the air threshold level to that of the fluid sensing probe signal; and
wherein the controller is programmed to activated the switch to energize the bilge pump motor if the fluid sensing probe signal is not equal to the air threshold level; and
wherein the controller is programmed to de-energize the bilge pump motor if the sensor signal is equal to the air threshold level.

2. The apparatus for controlling a bilge pump according to claim 1, further comprising:
a probe in contact with a water sample for providing an water threshold level;
wherein the controller is programmed to de-energize the bilge pump motor if the sensor signal is equal to the water threshold level.

3. The apparatus for controlling a bilge pump according to claim 1, further comprising multiple fluid level probes;
wherein the controller is programmed to compare each fluid level probe signal to the air sample threshold signal; and
wherein the controller is programmed to energize the bilge pump motor at a predetermined fluid probe level if the predetermined fluid probe level is not equal to the air sample threshold level; and
wherein the controller is programmed to de-energize the bilge pump at predetermined fluid probe level if the predetermined fluid probe is level is equal to the air sample threshold level.

4. The apparatus for controlling a bilge pump according to claim 3, wherein the controller is programmed to dynamically change the fluid probe used to energize the bilge pump motor;
and wherein the controller is programmed to dynamically change the fluid probe used to de-energize the bilge pump motor.

5. The apparatus for controlling a bilge pump according to claim 1, further comprising a probe in contact with oil sample for providing an oil threshold;
wherein the controller is programmed to compare the fluid sensor signal to the oil threshold; and
wherein the controller is programmed to de-energize the bilge pump motor if the fluid sensor signal is equal to the oil threshold level.

6. The apparatus for controlling a bilge pump according to claim 1, further comprising in combination;
a circuit to dynamically select the positive voltage and negative input voltage from the bilge switch input connections;
a circuit to power the bilge switch apparatus from the dynamically selected bilge input connections when the bilge pump is de-energized;
a circuit to power the bilge switch apparatus from a reserve power source while the bilge pump is energized;
a circuit to dynamically load the bilge switch connections to supply power to the bilge pump motor;
wherein the apparatus controller application controls the bilge pump motor and monitors the operation of the electronic apparatus for controlling a bilge pump.

7. The apparatus for controlling a bilge pump according to claim 1, further comprising in combination:
a wireless communication module;
a compatible remote wireless communication device;
wherein the wireless communication module is programmed to receive commands from the compatible remote wireless communication device; and
wherein the apparatus controller is programmed to accept commands from the compatible remote wireless communication device.

8. The apparatus according to claim 7, wherein the bilge pump controller application responds to commands from a compatible remote wireless communication device to transfer bilge switch data to the remote device; and
wherein the bilge pump controller application responds to commands to alter the bilge pump controller operational parameters.

9. The apparatus according to claim 8, wherein the compatible remote wireless communication device is a smartphone;
wherein a compatible smartphone application displays the alarms and operational information received from the bilge pump controller; and
wherein the compatible smartphone application updates the bilge pump controllers operational parameters.

10. The apparatus according to claim 8, the system further comprising in combination:
one or more bilge pump controllers with wireless communication modules;
wherein the wireless communication modules are programmed to receive commands from a compatible remote wireless communication device;
wherein a remote wireless communication device with a compatible application to scan for compatible sump pump controllers; and
wherein the remote wireless communication device logs the data received from compatible bilge pump controllers;
wherein the remote wireless communication device sends control parameters to the compatible sump pump controllers.

11. A system for controlling a bilge pump, the system comprising in combination:
a probe for providing a probe signal indicating the presence of fluid at the probe;
a probe in contact with an air sample for providing an air threshold level;
a controller in communication with the probes to receive the probes signals;
an electronically activated switch for controlling a bilge pump motor;
wherein the controller is programmed to compare the air threshold level to that of the fluid sensing probe signal; and
wherein the controller is programmed to activated the switch to energize the bilge pump motor if the fluid sensing probe signal is not equal to the air threshold level; and
wherein the controller is programmed to de-energize the bilge pump motor if the sensor signal is equal to the air threshold level.

12. The system for controlling a bilge pump according to claim 11, further comprising:
a probe in contact with a water sample for providing an water threshold level;
wherein the controller is programmed to de-energize the bilge pump motor if the sensor signal is equal to the water threshold level.

13. The system for controlling a bilge pump according to claim 11, further comprising multiple fluid level probes;
wherein the controller is programmed to compare each fluid level probe signal to the air sample threshold signal; and
wherein the controller is programmed to energize the bilge pump motor at a predetermined fluid probe level if the predetermined fluid probe level is not equal to the air sample threshold level; and
wherein the controller is programmed to de-energize the bilge pump at predetermined fluid probe level if the predetermined fluid probe is level is equal to the air sample threshold level.

14. The system for controlling a bilge pump according to claim 13, wherein the controller is programmed to dynamically change the fluid probe used to energize the bilge pump motor;
and wherein the controller is programmed to dynamically change the fluid probe used to de-energize the bilge pump motor.

15. The system for controlling a bilge pump according to claim 11, further comprising a probe in contact with oil sample for providing an oil threshold;
wherein the controller is programmed to compare the fluid sensor signal to the oil threshold; and
wherein the controller is programmed to de-energize the bilge pump motor if the fluid sensor signal is equal to the oil threshold level.

16. The system according to claim 11, further comprising in combination:
a wireless communication module;
a compatible remote wireless communication device;
wherein the wireless communication module is programmed to receive commands from the compatible remote wireless communication device; and
wherein the apparatus controller is programmed to accept commands from the compatible remote wireless communication device.

17. The system according to claim 16, wherein the bilge pump controller application responds to commands from a compatible remote wireless communication device to transfer bilge switch data to the remote device; and
wherein the bilge pump controller application responds to commands to alter the bilge pump controller operational parameters.

18. The system according to claim 17, wherein the compatible remote wireless communication device is a smartphone;
wherein a compatible smartphone application displays the alarms and operational information received from the bilge pump controller; and
wherein the compatible smartphone application updates the bilge pump controllers operational parameters.

19. The system according to claim 17, the system further comprising in combination:
one or more bilge pump controllers with wireless communication modules;
wherein the wireless communication modules are programmed to receive commands from a compatible remote wireless communication device;
wherein a remote wireless communication device with a compatible application to scan for compatible sump pump controllers; and
wherein the remote wireless communication device logs the data received from compatible bilge pump controllers;
wherein the remote wireless communication device sends control parameters to the compatible sump pump controllers.

20. The system according to claim 17, further comprising:
a second communications device, connected to the internet;
a compatible website application;
wherein the website application displays device logs, alarms, and status information; and
wherein the website application accepts commands for altering sump operational parameters.
